(19) United States
(12) Patent Application Publication
(10) Pub. No.: US 2025/0150418 A1
(43) Pub. Date: May 8, 2025

(54) METHOD, APPARATUS, DEVICE AND STORAGE MEDIUM FOR SESSION INTERACTION

(71) Applicant: Beijing Zitiao Network Technology Co., Ltd., Beijing (CN)

(72) Inventors: Yiyu HE, Beijing (CN); Zhong WANG, Beijing (CN); Qingyu ZHANG, Beijing (CN); Jiangwen WANG, Beijing (CN)

(21) Appl. No.: 18/942,207

(22) Filed: Nov. 8, 2024

(30) Foreign Application Priority Data
Nov. 8, 2023 (CN) 202311483250.0
Nov. 22, 2023 (CN) 202311569310.0

(51) Int. Cl. H04L 51/063; H04L 51/02; H04L 51/046

(52) U.S. Cl. CPC H04L 51/063; H04L 51/02; H04L 51/046

(57) ABSTRACT

Embodiments of the disclosure provide a method, an apparatus, a device and a storage medium for session interaction. The method includes: in a session between a user and a digital assistant, in response to receiving a first session message of the user, presenting a first reply message of the digital assistant for the first session message, the first reply message comprising first content, the first content being generated by a model based on a user requirement corresponding to the first session message; in response to receiving a collection request for the first content, adding the first content in the first reply message to a content collection page of the user; and in response to detecting a content viewing request, presenting second content in the content collection page, the second content being regenerated by the model based on the user requirement.

### CROSS-REFERENCE

This application claims priority to Chinese Patent Application No. 202311483250.0, filed on Nov. 8, 2023, and entitled “METHOD, APPARATUS, DEVICE, AND STORAGE MEDIUM FOR SESSION INTERACTION” which claims priority to Chinese Patent Application No. 202311569310.0, filed on Nov. 22, 2023, and entitled “METHOD, APPARATUS, DEVICE, AND STORAGE MEDIUM FOR SESSION INTERACTION,” the entire contents of each of which are incorporated herein by reference.

### FIELD

Example embodiments of the present disclosure generally relate to the field of computer, and in particular, to a method, an apparatus, a device, and a computer-readable storage medium for session interaction.

### BACKGROUND

With the development of information technologies, various terminal devices may provide various services to people in aspects of work and life, etc. Applications providing a service may be deployed in the terminal device. The terminal device presents the corresponding content through a user interface of the application, realizes interaction with a user, and meets various types of requirements of the user. Therefore, a rich application interaction interface is an important means of improving user experience. The terminal device or application may provide functions such as a digital assistant to the user to assist the user in using the terminal device or application. How to improve the flexibility of interaction between a user and a digital assistant is a technical problem to be explored currently.

### SUMMARY

In a first aspect of the present disclosure, a method of session interaction is provided. The method comprises in a session between a user and a digital assistant, in response to receiving a first session message of the user, presenting a first reply message of the digital assistant for the first session message, the first reply message comprising first content, the first content being generated by a model based on a user requirement corresponding to the first session message; in response to receiving a collection request for the first content, adding the first content in the first reply message to a content collection page of the user; and in response to detecting a content viewing request, presenting second content in the content collection page, the second content being regenerated by the model based on the user requirement.

In a second aspect of the present disclosure, an apparatus for session interaction is provided. The apparatus comprises a message presenting module, configured to, in a session between a user and a digital assistant, in response to receiving a first session message of the user, present a first reply message of the digital assistant for the first session message, the first reply message comprising first content, the first content being generated by a model based on a user requirement corresponding to the first session message; a content adding module, configured to, in response to receiving a collection request for the first content, add the first content in the first reply message to a content collection page of the user; and a content presenting module configured to, in response to detecting a content viewing request, present second content in the content collection page, the second content being regenerated by the model based on the user requirement.

In a third aspect of the present disclosure, an electronic device is provided. The electronic device comprises at least one processing unit; and at least one memory coupled to the at least one processing unit and storing instructions for execution by the at least one processing unit. The instructions, when executed by the at least one processing unit, cause the electronic device to perform the method of the first aspect.

In a fourth aspect of the present disclosure, a computer-readable storage medium is provided. The computer-readable storage medium has a computer program stored thereon, and the computer program, when executed by a processor, implements the method of the first aspect.

It should be understood that the content described in this section is not intended to limit the key features or important features of the embodiments of the present disclosure, nor is it intended to limit the scope of the present disclosure. Other features of the present disclosure will become apparent from the following description.

### BRIEF DESCRIPTION OF THE DRAWINGS

The above and other features, advantages, and aspects of various embodiments of the present disclosure will become more apparent from the following detailed description in conjunction with the accompanying drawings. In the drawings, the same or similar reference signs refer to the same or similar elements, in which:

FIG. 1 illustrates a schematic diagram of an example environment in which embodiments of the present disclosure can be implemented;

FIG. 2 illustrates a flowchart of an information flow of a session interaction according to some embodiments of the present disclosure;

FIG. 3 illustrates an example of a client interface for session interaction according to some embodiments of the present disclosure;

FIG. 4 illustrates an example of a content collection page according to some embodiments of the present disclosure;

FIG. 5 illustrates a flowchart of a process for session interaction according to some embodiments of the present disclosure;

FIG. 6 illustrates a schematic structural block diagram of an apparatus for session interaction according to some embodiments of the present disclosure; and

FIG. 7 illustrates a block diagram of an electronic device in which one or more embodiments of the present disclosure may be implemented.

### DETAILED DESCRIPTION

The embodiments of the present disclosure will be described in more detail below with reference to the accompanying drawings. Although some embodiments of the present disclosure are illustrated in the drawings, it should be understood that the present disclosure can be implemented in various forms and should not be construed as being limited to the embodiments set forth herein. Rather, these embodiments are provided for a more thorough and complete understanding of the present disclosure. It should be understood that the drawings and the embodiments of the present disclosure are provided for illustrative purposes only and are not intended to limit the scope of protection of the present disclosure.

In the description of the embodiments of the present disclosure, the term “including” and the like should be understood as non-exclusive inclusion, that is, “including but not limited to”. The term “based on” should be understood as “based at least in part on.” The term “an embodiment” or “the embodiment” should be understood as “at least one embodiment”. The term “some embodiments” should be understood as “at least some of the embodiments”. Other explicit and implicit definitions may also be included below.

Herein, unless explicitly stated, “in response to A” performing a step is not intended that this step is performed immediately after “A”, but may include one or more intermediate steps.

It is to be understood that the data involved in the technical solution, including but not limited to the data itself, the obtaining, usage, storage or deletion of the data, should comply with the requirements of corresponding laws and regulations and relevant provisions.

It is to be understood that, before using the technical solutions disclosed in the various embodiments of the present disclosure, the related user shall be informed of the type, the scope of use, and use scenarios and so on of information involved in the present disclosure in an appropriate manner in accordance with relevant laws and regulations, and the related user's authorization shall be obtained. The related user may include any type of subject of rights, e.g. individuals, enterprises, organizations.

For example, in response to receiving an active request from a user, prompt information is sent to the related user to explicitly prompt the related user that an operation requested by the related user will require to obtain and use information of the related user, so that the related user can autonomously select, according to the prompt information, whether to provide the information to software or hardware, such as an electronic device, an application program, a server, or a storage medium that performs the operations of the technical solutions of the present disclosure.

As an optional but non-limiting implementation, in response to receiving an active request of the user, the prompt information is sent to the user, for example, in the form of a pop-up window, in which the prompt information may be presented in the form of text. In addition, the pop-up window may further carry a selection control for the user to select “agree” or “not agree” to provide the personal information to the electronic device.

It should be understood that the above process for notifying and obtaining the user's authorization is merely illustrative, and do not limit the implementations of the present disclosure, and other approaches that meet the relevant laws and regulations may also be applied to the implementations of the present disclosure. In the embodiments of the present disclosure, enabling of the functions related to the digital assistant, the acquired data, the processing and storing modes of data, and the like shall all be authorized in advance by the user and other subjects of rights associated with the user, and shall comply with related laws and regulations and protocol rules agreed among the subject of rights.

As used herein, the term “model” may learn an association relationship between respective inputs and outputs from training data such that a corresponding output may be generated for a given input after training is done. Generation of the model may be based on machine learning techniques. Deep learning is a machine learning algorithm that processes inputs and provides corresponding outputs by using multiple layers of processing units. Neural network model is an example of the model based on deep learning. As used herein, the “model” may also be referred to as a “machine learning model,” “learning model,” “machine learning network,” or “learning network,” and these terms may be used interchangeably herein.

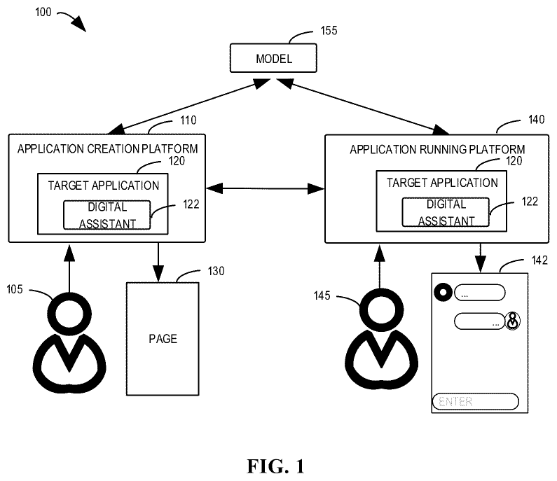

FIG. 1 illustrates a schematic diagram of an example environment 100 in which embodiments of the present disclosure can be implemented. The environment 100 relates to an application creation platform 110 and an application running platform 140.

As shown in FIG. 1, the application creation platform 110 may provide the user 105 with an application creation and publishing environment. The user 105 may be referred to as an application creation user, creator. In some embodiments, the application creation platform 110 may be a low code platform that provides a set of tools for application creation. The application creation platform 110 may support visual development of various applications, so that the developer may skip the manual coding process, accelerate the development cycle and reduce the cost of the application. The application creation platform 110 may support any suitable platform for a user to develop one or more types of applications, for example, may include an Application-Platform-as-a-Service (aPaaS) based platform. Such a platform can support efficient development of applications by users, and implement operations, such as application creation, application function adjustment, etc.

The application creation platform 110 may be deployed locally on the terminal device of the user 105 and/or may be supported by the server device. For example, the terminal device of the user 105 may run a client of the application creation platform 110, and the client may support interaction between the user and the application creation platform 110 provided by the server. In case the application creation platform 110 runs locally on the user's terminal device, the user 105 may directly interact with the local application creation platform 110 by using the terminal device. In case the application creation platform 110 runs on the server device, the server device may provide service to the client running in the terminal device based on the communication connection with the terminal device. The application creation platform 110 may present a respective page 130 to the user 105 based on the operation of the user 105 to output, to the user 105, and/or receive, from the user 105, information related to the application creation.

In some embodiments, the application creation platform 110 may be associated to a respective database, wherein the data or information needed by the application creation process supported by the application creation platform 110 is stored. For example, the database may store code and description information, etc. corresponding to each functional module for constituting the application. The application creation platform 110 may also perform operations such as invoking, adding, deleting, updating, and the like on functional modules in the database. The database may also store operations that may be performed on different functional blocks. For example, in a scenario in which an application is to be created, the application creation platform 110 may invoke, from a database, a corresponding functional block to build the application.

In an embodiment of the present disclosure, the user 105 may create a target application 120 on the application creation platform 110 as needed, and publish the target application 120. The target application 120 may be published to any suitable application running platform 140 as long as the application running platform 140 is able to support the running of the target application 120. After publication, the target application 120 may be used by one or more users 145 for operation. The user 145 may be referred to as a terminal user of the target application 120. In some embodiments, the target application 120 may include or be implemented as a digital assistant 122.

The digital assistant 122 may be configured to have an intelligent session. In the example shown in FIG. 1, the digital assistant 122 may be integrated into the target application 120 as a part of the target application 120 to assist in performing task processing within the target application 120. In other examples, the digital assistant 122 may be configured as an application that runs independently, such as a web application or other types of application. In such an example, the digital assistant 122 and the target application 120 may be considered as the same application. The digital assistant 122 is provided to assist the user in various types of task processing requirements in different applications and scenarios. During interaction with the digital assistant 122, the user inputs an interaction message and in response to the user input, the digital assistant 122 provides a reply message. Generally, the digital assistant 122 can support users to input questions in natural language and perform tasks and provide replies based on understanding of natural language input and logical reasoning capabilities.

In some embodiments, digital assistant 122 may interact with the user as a contact of user 145. For example, the digital assistant 122 may be implemented in an instant messaging (IM) application. The digital assistant 122 may interact with the user 145 in a single-chat session with the user 145. In some embodiments, the digital assistant 122 may interact with multiple users in a group-chat session that comprises multiple users.

For each user 145, the client of the application running platform 140 may present, in a client interface, an interaction window 142 of the target application 120 or the digital assistant 122, such as a session window with the digital assistant 122. User 145 may input a session message in the session window, and target application 120 may determine a reply message of digital assistant 122 based on created configuration information and present it to the user in the interaction window 142. In some embodiments, the interaction message with the target application 120 may include a multimodal form of messages, such as a text message (e.g., natural language text), a voice message, an image message, a video message, etc., depending on the configuration of the target application 120.

Similar to the application creation platform 110, the application running platform 140 may be deployed locally on the terminal device of each user 145, and/or may be supported by the server device. For example, the terminal device of the user 145 may run a client of the application running platform 140, and the client may support interaction between the user and the application running platform 140 provided by the server. In case the application running platform 140 runs locally on the user's terminal device, the user 145 may directly interact with the local application running platform 140 by using the terminal device. In case the application running platform 140 runs on the server device, the server device may provide service to the client running in the terminal device based on the communication connection with the terminal device. The application running platform 140 may present a corresponding application page to user 145 based on the operation of user 145 to output, to the user 145, and/or receive, from the user 145, information related to application usage.

In some embodiments, implementation of at least partial function of the target application 120, and/or implementation of at least partial function of the digital assistant 122 in the target application 120 may be based on a model. In the creation or running process of the target application 120, one or more models 155 may be invoked. In the target application 120, the digital assistant 122 may utilize the model 155 to understand the user input and provide a reply to the user based on an output of the model 155.

In the creation process, test of the target application 120 by the application creation platform 110 needs to utilize model 155 to determine that the running result of the target application 120 meets expectations. In the running process, in response to different operating requests of the user of the target application 120, the application running platform 140 may need to utilize model 155 to determine a response result to the user.

Although shown as separated from the application creation platform 110 and the application running platform 140, the one or more models 155 may run on the application creation platform 110 and/or the application running platform 140, or other remote servers. In some embodiments, the model 155 may be a machine learning model, a deep learning model, a learning model, a neural network, or the like. In some embodiments, the model may be based on a language model (LM). The language model can have question-answer capability by learning from a large amount of corpus. The model 155 may also be based on other suitable models.

The application creation platform 110 and/or the application running platform 140 may run on appropriate electronic devices. The electronic device herein may be any type of device having computing capability, comprising a terminal device or a server device. The terminal device may be any type of mobile terminal, fixed terminal, or portable terminal, comprising a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a pointing device, a television receiver, a radio broadcast receiver, an e-book device, a gaming device, or any combination of the foregoing, comprising accessories and peripherals of these devices, or any combination thereof. The server device may include, for example, a computing system/server, such as a mainframe, an edge computing node, a computing device in a cloud environment, or the like. In some embodiments, the application creation platform 110 and/or the application running platform 140 may be implemented based on cloud services.

It should be understood that the structure and function of the environment 100 are described for exemplary purposes only and do not imply any limitation to the scope of the present disclosure. For example, while FIG. 1 shows a single user interacting with the application creation platform 110 and a single user interacting with the application running platform 140, in practice multiple users may access the application creation platform 110 to each create a digital assistant, and each digital assistant may be used to interact with multiple users.

The digital assistant can be used as a tool for effective work, learning and life of people. Generally, an interaction process with a digital assistant mainly focuses on a session, and a process thereof has features such as fragmentation, uncertainty etc., and in some scenarios (for example, an enterprise office scenario), content such as data analysis, knowledge question and answer, etc. output by a digital assistant has long-term reuse value. It is desirable to be able to provide a way to invoke the contents output by the digital assistant so that a user can reuse or view these contents through a simple operation.

According to an embodiment of the present disclosure, an improved solution for session interaction is provided. According to the solution, in a session between the user and the digital assistant, in response to receiving the first session message of the user, the first reply message of the digital assistant for the first session message is presented. The first reply message comprises first content, and the first content is generated by a model based on a user requirement corresponding to the first session message. In response to receiving a collection request for the first content, the first content in the first reply message is added to a content collection page of the user. In response to detecting a content viewing request, second content is presented in the content collection page, the second content being regenerated by the model based on the user requirement.

Therefore, by providing a modularized and simple input session interaction solution, the user can conveniently and quickly view the content replied by the digital assistant historically, and efficiency of the interaction between the user and the digital assistant can be improved.

Some example embodiments of the present disclosure will be described in detail below with reference to examples of the accompanying drawings. It should be understood that the pages shown in the drawings are merely examples, and in practice, there may exist various page designs. Individual graphical elements in a page may have different arrangements and different visual representations, one or more of which may be omitted or replaced, and there may be one or more other elements. Embodiments of the present disclosure are not limited in this regard.

The digital assistant creation process described in the embodiments of the present disclosure may be implemented on an application running platform, a terminal device on which an application running platform is installed, and/or a server corresponding to an assistant creation platform. For discussion purposes, the following examples are described from the perspective of an application running platform, for example, the application running platform 140 as shown in FIG. 1. The user interface presented by the application running platform 140 may be presented via a terminal device of the user 145, and the user input may be received via the terminal device of the user 145.

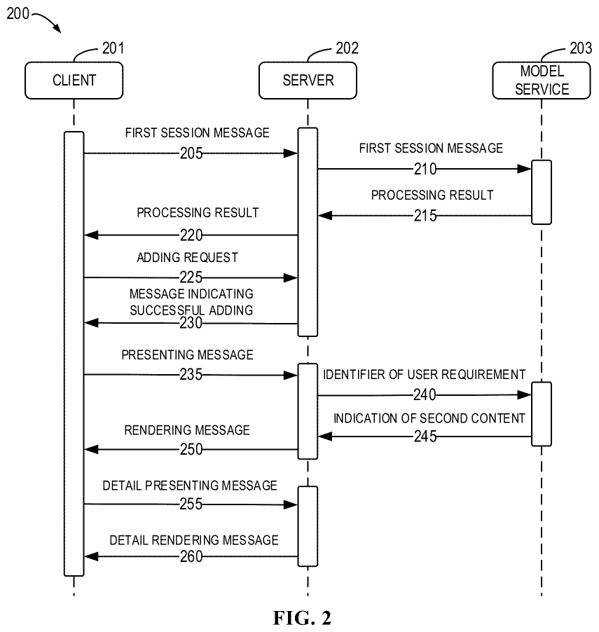

FIG. 2 shows a flowchart of an information flow 200 of session interaction according to some embodiments of the present disclosure. Information flow 200 involves client 201, server 202, and model service 203. The client 201 herein may be, for example, a client device of the application running platform 140, and the server 202 may be, for example, a server device of the application running platform 140. The client 201, the server 202, and the model service 406 may correspond to the application running platform 140 in FIG. 1. For convenience of discussion, the information flow 200 will be described with reference to the environment 100 of FIG. 1.

In an embodiment of the present disclosure, the digital assistant is used to interact with a user. The client 201 may present, in a client interface, an interaction window between the user and the digital assistant. The interaction window between the user and the digital assistant may comprise a session window, and in the session window, the interaction between the user and the digital assistant may be presented in a form of session message. Alternatively or additionally, the interaction window between the user and the digital assistant may further comprise other types of windows, such as a window of a floating window mode where the user may trigger the digital assistant to perform a corresponding operation by inputting an instruction, selecting a shortcut instruction, or the like. As an intelligent assistant, the digital assistant has an intelligent session and information processing capability. In the interaction window, the user inputs an interaction message, and in response to the user input, the digital assistant provides a reply message.

In some embodiments, the user may interact with the digital assistant by sending and/or receiving messages in the conversation window. For example, in response to detecting the text input by the user in the input box, the client 201 may determine that a session message from the user is received. For example, in response to detecting a trigger operation (for example, a click operation, a long-press operation, etc.) of the user on an audio control, the client 201 may further collect the user audio. The client 201 may determine the audio or the text content corresponding to the audio as the message content (that is, the session message from the user) to be sent by the user.

In the information flow 200, in a session between the user and the digital assistant, in response to receiving a first session message of the user, the client 201 sends (205) the first session message to the server 202. For example, the client 201 may send the first session message to the server 202 through a communication connection with the server 202.

In response to receiving the first session message, the server 202 passes (210) it to the model service 203 to provide the first session message to the model. It may be understood that the server 202 may not process the first session message, and directly passes the received first session message to the model service 203.

As mentioned above, the model service 203 may invoke one or more models, such as the capabilities of the model 155. After receiving the first session message, the model service 203 may invoke the model 155 to process the first session message. Specifically, the model 155 may determine a user requirement indicated by the first session message, and based on at least the user requirement, generate first content corresponding to the first session message. In some embodiments, based on the target data source and the user requirement, the model 155 may generate the first content. For example, in case the user requirement indicates a summary of the data in the target data source, the model 155 may generate the first content based on the target data source and the user requirement. The model service 203 may send to the server 202 the processing result for the first session message.

In some embodiments, the model service 203 or the model 155 may further determine whether the first content is content that can be reused. If the first content can be reused (e.g., the first content is a chart type of content), the model service 203 or the model 155 can also add a flag to the first content indicating that the first content can be reused. If the first content is not reusable (e.g., the first content is plain text content), the model service 203 or the model 155 may add a flag to the first content indicating that the first content is not reusable, or add no flag to the first content. In some embodiments, the model service 203 or the model 155 may not need to determine whether the first content is reusable. In such a case, all the contents determined for the user requirement may be reusable by default.

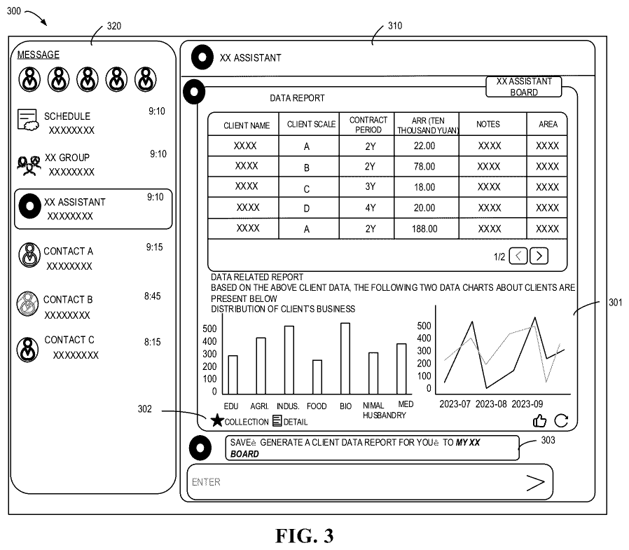

The server 202 may receive (215), from the model service 203, a processing result for the first session message, which may comprise, for example, an indication of the first content and a flag for whether the first content is reusable. The server 202 sends (220) the processing result to the client 201. In response to receiving the processing result, the client 201 may determine whether the processing result comprises a flag for whether the first content is reusable. If the processing result comprises a flag for the first content being reusable, the client 201 may present, in a session between the user and the digital assistant, a first reply message of the digital assistant for the first session message, the first reply message comprising the first content. FIG. 3 shows an example 300 of a client interface for session interaction according to some embodiments of the present disclosure. As shown in FIG. 3, in example 300, a main session window between a digital assistant (shown as “XX assistant” in the figure) and the user is presented in region 310. The digital assistant may be considered as one of the user's contacts, and presented in the information flow of the instant messaging application, and the information flow is presented in region 320 of example 300. The user selects the digital assistant in the instant messaging application so as to enter the main session window. The client 201 may present, in the main session window, a first reply message 301 (e.g., a reply message from an “XX assistant”). The first content is presented in the first reply message 301. For example, in response to detecting a click operation on the first reply message, the client 201 may determine that a collection request for the first content in the first reply message is detected. For example, in response to receiving a session message (e.g., a voice or text message “favorites the first content”) sent by the user instructing to add the first content to the content collection page of the user, the client 201 may further determine that a collection request for the first content in the first reply message is detected. In response to detecting a collection request for the first content in the first reply message, the client 201 may add the first content in the first reply message to a content collection page (for example, a data board) of the user.

In some embodiments, the first reply message 301 may further comprise an operation control for the first content, for example, a collection control 302. In response to detecting a trigger operation (e.g., a click operation, a double click operation, a long-press operation, or the like depending on the application configuration) for the collection control 302 in the first reply message, the client 201 may determine that a trigger for the collection control 302 is received. In response to receiving the trigger for the collection control 302, the client 201 may add the first content in the first reply message to the content collection page of the user.

Alternatively or additionally, although the user-triggered collection operation is for the first content or the first reply message, in an embodiment of the present disclosure, the user requirement (or user intent) corresponding to the first reply message is collected in the content collection page, and the user requirement may be determined based on the first session message (and possibly a context content related to the first session message). Through the collection operation, when the viewing operation or the updating operation on the content is triggered subsequently, update of the first content that has been collected in the content collection page can be realized to display the updated content matching the collected user requirement.

Referring back to FIG. 2, in some embodiments, the client 201 may send (225) to the server 202 an adding request instructing to add the first content to the user's content collection page. In response to the adding request, the server 202 adds the first content to the content collection page of the user. In response to completion of the addition, the server 202 may send (230) to the client 201 a message indicating successful adding.

In some embodiments, in response to receiving the message indicating successful adding (that is, in response to the first content being added to the content collection page of the user), the client 201 may present, in the session, a prompt message that the first content is added to the content collection page, and the prompt message may comprise, for example, an entry indication for the content collection page. In this way, the user can know where to view the collected contents later. In some embodiments, the entry indication in the prompt message may comprise an entry control, through the triggering of which, it is possible to jump to the content collection page. For example, in response to detecting a trigger operation on the entry control, the client 201 may determine that a content viewing request is received. For example, as shown in FIG. 3, the client 201 may present a prompt message 303. The prompt message 303 may comprise an entry control “my XX board”. For example, in response to detecting a trigger operation on the entry control “my XX board”, the client 201 may determine that a content viewing request is received.

Alternatively or additionally, in some embodiments, in response to receiving, from the user, a session message instructing to view the first content, the client 201 may further determine that a content viewing request is received. In some embodiments, the client 201 may also present an operation control for the content collection page in a region other than the session (e.g., a functional region). In response to detecting a trigger operation on the operation control, the client 201 may determine that a content viewing request is received.

In response to detecting the content viewing request, the client 201 presents second content in the content collection page, the second content being regenerated by a model based on the user requirement. The second content may be, for example, content generated based on the latest target data source. That is, in case the target data source was not updated, the second content and the first content may comprise the same content. In case the target data source was updated, the second content generated based on the updated target data source may be different from the first content.

Regarding the specific manner of presenting the second content, in some embodiments, in response to detecting the content viewing request, the client 201 may automatically generate the second content and present the second content in the content collection page. Specifically, in response to the content viewing request, the client 201 may send (235) to the server 202 a presentation message instructing to present the content collection page. In response to receiving the presentation message, the server 202 provides (240) the model service 203 with an identifier of a user requirement corresponding to the first session message. The model service 203 may determine second content to be presented based on the identifier, and send (245) to the server 150 an indication of the second content. In response to the indication, the server 150 may send (250) to the client 201 a rendering message instructing to render the content collection page. The rendering message may comprise, for example, the second content. In response to receiving the rendering message, the client 201 renders the content collection page based on the rendering message. The second content is presented in the rendered content collection page.

In some embodiments, in response to detecting a content viewing request, the client 201 may further automatically present the first content in the content collection page. In some embodiments, in response to the predetermined content generation policy, the client 201 may generate the second content and replace the first content presented in the content collection page by the second content. In some embodiments, the predetermined content generation policy may be, for example, periodically generated according to a predetermined execution interval, and/or updated in response to a data source associated with the user requirement. Specifically, in response to receiving the content viewing request, the client 201 may present the previously added first content in the content collection page by default. For example, the client 201 may present a presentation area corresponding to the first content, and present the first content in the presentation area. Further, to enable the user to view, in the content collection page, the content generated based on the latest target data source, in response to detecting an update request for the first content, the client 201 may further present, in the presentation area, the second content regenerated based on the updated target data source. Regarding the specific manner of detecting the update request, in some embodiments, the client 201 may present, in the presentation area corresponding to the first content, an update control. In response to detecting a trigger operation on the update control, the client 201 may determine that an update request for the first content is detected, and present, in the presentation area, the second content regenerated based on the updated target data source. In some embodiments, in response to receiving a user input instructing to update the first content and present the second content (e.g., text “updates the first content and present the updated result”), the client 201 may further determine that an update request for the first content is detected and present, in the presentation area, the second content regenerated based on the updated target data source.

For example, the client 201 may present a presentation area corresponding to the second content, and present the second content in the presentation area. The presentation area corresponding to the second content and the presentation area corresponding to the first content may be the same presentation area. In this case, in response to receiving the content viewing request, for example, the client 201 may send to the server 202 a first presentation message and receive, from the server 202, a first rendering message comprising the first content or an instruction instructing to render the first content. In turn, in response to detecting a trigger operation on the update control, the client 201 may send to the server 202 a second presentation message and receive, from the server 202, a second rendering message comprising the second content.

In some embodiments, in response to detecting a content viewing request, the client 201 may further directly present, in the content collection page, the second content generated based on the updated target data source. For example, the client 201 may present a presentation area corresponding to the second content, and present the second content in the presentation area. In this case, in response to detecting the content viewing request, for example, the client 201 may send to the server 202 a presentation message instructing to present the content collection page, and directly receive, from the server 202, a rendering message comprising the second content.

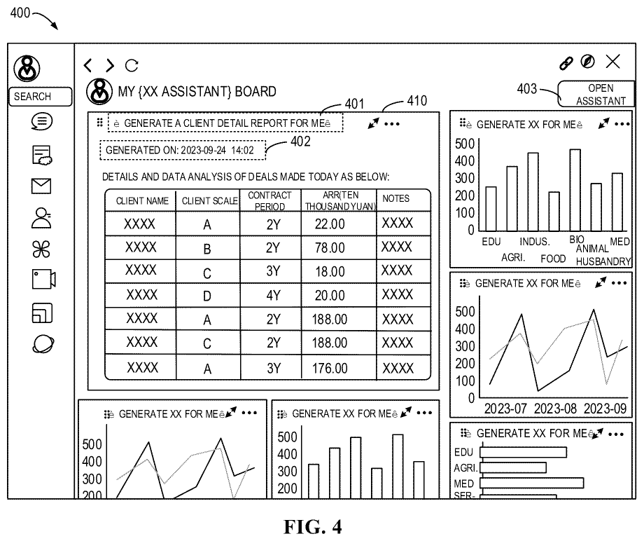

In some embodiments, the content collection page may comprise at least one chart type and/or at least one form type of content. FIG. 4 shows an example 400 of a content collection page according to some embodiments of the present disclosure. As shown in FIG. 4, multiple contents may be presented in example 400, which may comprise a chart type of content and a form type of content.

In some embodiments, the client 201 may present at least a part of the first session message in a presentation area corresponding to the first content or the second content in the content collection page. For example, the client 201 may determine a message content indicating user requirement in the first session message, and present the message content in the presentation area. The message content may be determined by the client 201 and/or the server 202 (that is, the application running platform 140) by itself, or may be determined by using a model provided by the model service 203. As an example, as shown in FIG. 4, for the presentation area 410, if the presentation area 410 is a presentation area corresponding to the first content or the second content, the client 201 may present, in the presentation area 410, the message 401 from the user, and the message 401 may be at least a part of the first session message.

In some embodiments, the client 201 may further present the generation time of the second content in association with the second content. As an example, as shown in FIG. 4, the client 201 may further present the generation time 402 in the presentation area 410. The generation time 402 may be used to prompt a generation moment of the second content.

Since the target data source may be updated for multiple times, and different second contents may be obtained based on target data sources of different updated versions, in some embodiments, in order to facilitate the user to view the second content of different historical versions, the client 201 may further present the version viewing entry in association with the second content. In response to detecting a trigger for the version viewing entry, for example, the client 201 may present one or more version options corresponding to the second content. Each version option herein corresponds to a historical version of the content generated by the model based on user requirement.

In some embodiments, for the content that has been collected in the content collection page, the manner in which the collected content update is triggered may be manually triggered by the user, or may be actively triggered according to a certain policy (for example, regularly triggered, or triggered in response to a change of a target data source associated with the user requirement). Alternatively or additionally, content updated each time may be saved as a corresponding version for subsequent viewing by the user.

In some embodiments, in response to detecting an awakening request for the digital assistant in the content collection page, the client 201 may further present a session between the user and the digital assistant. In response to receiving, in the content collection page, a user input instructing to present a session between the user and the digital assistant (e.g., receiving a voice or text instruction of the user “open a session with the digital assistant”), for example, the client 201 may determine that an awakening request for the digital assistant is detected, and present the session between the user and the digital assistant. In some embodiments, in order to facilitate the user to switch to the session with the digital assistant in the content collection page, the client 201 may further provide an awakening control for the digital assistant in the presentation area of the content collection page. In response to a trigger to the awakening control, the client 201 may determine that an awakening request for the digital assistant is detected, and present the session between the user and the digital assistant.

As an example, as shown in FIG. 4, the client 201 may further present the awakening control 403 in the example 400. In response to a trigger for the awakening control 403, for example, the client 201 may switch to present a main session window between the user and the digital assistant (e.g., the example 300 shown in FIG. 3) and present a session between the user and the digital assistant in the main session window. In response to a trigger for the awakening control 403, for example, the client 201 may further awake the digital assistant directly and present a branch session window for the user to interact with the digital assistant in the example 400. The client 201 may in turn present a session between the user and the digital assistant in the branch session window.

In some embodiments, in response to receiving the detail viewing operation, the client 201 may further present detailed contents of the second content. As an example, in response to a click operation on the presentation area for presenting the second content, for example, the client 201 may determine that a detail viewing operation is received. As shown in FIG. 4, in response to detecting a click operation on the presentation area 410, the client 201 may for example determine that a detail viewing operation on the second content corresponding to the presentation area 410 is received.

In response to receiving the detail viewing operation, the client 201 may send (255) to the server 202 a detail presenting message instructing to present the detailed contents of the second content. In response to receiving (260) a detail rendering message from the server 202 instructing to render the detailed contents, the client 201 may in turn present detailed contents of the second content. For example, the client 201 may switch from the content collection page to a content viewing page corresponding to the second content, and present detailed contents of the second content in the content viewing page. Alternatively, or additionally, the client 201 may also directly present, in the content collection page, detailed contents of the second content, which is not limited by the present disclosure.

In summary, according to the embodiments of the present disclosure, the user can be enabled to conveniently and quickly view the content of the historically replied by the digital assistant by providing a modularized and simple input session interaction solution, which can improve efficiency of the interaction between the user and the digital assistant.

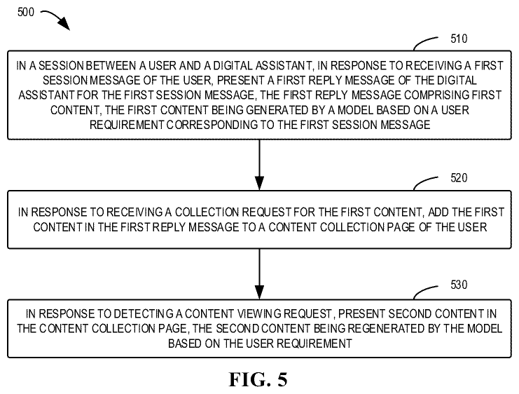

FIG. 5 illustrates a flowchart of a process 500 for session interaction in accordance with some embodiments of the present disclosure. The process 500 may be implemented at the application running platform 140. The process 500 is described below with reference to FIG. 1.

At block 510, in a session between a user and a digital assistant, in response to receiving a first session message of the user, the application running platform 140 presents a first reply message of the digital assistant for the first session message, the first reply message comprising first content, the first content being generated by a model based on a user requirement corresponding to the first session message.

At block 520, in response to receiving a collection request for the first content, the application running platform 140 adds the first content in the first reply message to a content collection page of the user.

At block 530, in response to detecting a content viewing request, the application running platform 140 presents second content in the content collection page, the second content being regenerated by the model based on the user requirement.

In some embodiments, the first reply message comprises a collection control for the first content, and wherein the collection request is based on a trigger for the collection control.

In some embodiments, the first content is generated based on a target data source, and wherein the target data source has been updated when the content viewing request is detected, and the second content is regenerated based on the updated target data source.

In some embodiments, presenting the first reply message comprises: providing a first session message to the model; receiving a processing result for the first session message from the model, the processing result comprising an indication of the first content and a flag for whether the first content is reusable; and in response to determining that the processing result comprises the flag for the first content being reusable, presenting the first reply message comprising the first content.

In some embodiments, presenting the second content comprises: providing, to the model, an identifier of the user requirement corresponding to the first session message; and receiving, from the model, an indication of the second content.

In some embodiments, the regeneration of the second content is responsive to at least one of the following: in response to detecting the content viewing request, in response to a predetermined content generation policy. In some embodiments, the predetermined content generation policy may be, for example, periodically generated according to a predetermined execution interval, and/or updated in response to a data source associated with the user requirement.

In some embodiments, the process 500 further comprises presenting, in the session, a prompt message that the first content is added to the content collection page, the prompt message comprising an entry indication for the content collection page.

In some embodiments, presenting the second content comprises: in response to detecting a trigger operation on the content collection page, presenting the second content in the content collection page.

In some embodiments, presenting the second content comprises: presenting a content collection page, the content collection page comprising at least a presentation area corresponding to the first content; and in response to detecting an update request for the first content, presenting the second content in the presentation area.

In some embodiments, the process 500 further comprises: presenting at least a part of the first session message in a presentation area corresponding to the first content or the second content in the content collection page.

In some embodiments, the process 500 further comprises presenting the generation time of the second content in association with the second content.

In some embodiments, the process 500 further comprises: presenting a version viewing entry in association with the second content; and in response to detecting a trigger for the version viewing entry, presenting one or more version options corresponding to the second content, each version option corresponding to a historical version of content generated by the model based on the user requirement.

In some embodiments, the process 500 further comprises: in response to detecting an awakening request for the digital assistant in the content collection page, presenting a session between the user and the digital assistant.

In some embodiments, an awakening control for the digital assistant is provided in a presentation area of the content collection page, the awakening request being based on a trigger for the awakening control.

In some embodiments, the content collection page comprises at least one of the following types of content: at least one chart type and at least one form type.

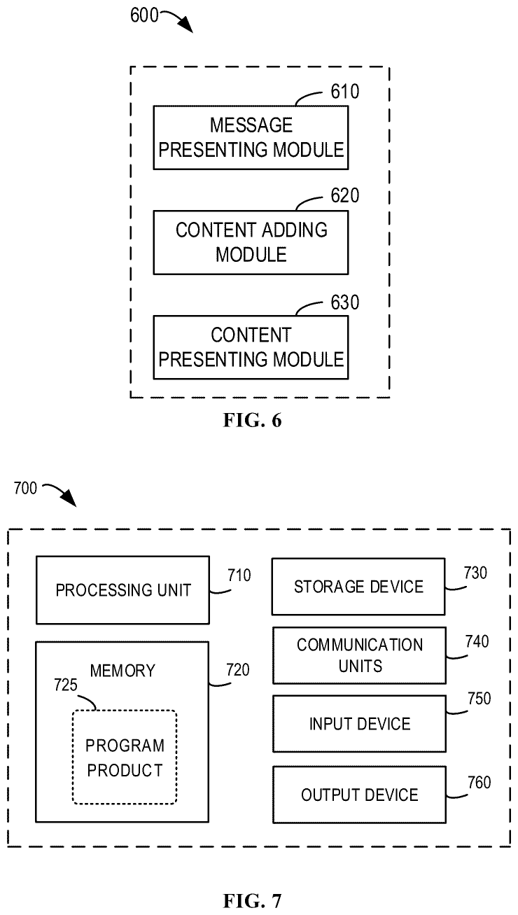

FIG. 6 illustrates a schematic structural block diagram of an apparatus 600 for session interaction, in accordance with some embodiments of the present disclosure. The apparatus 600 may be, for example, implemented in or included in the application running platform 140. Various modules/components in the apparatus 600 may be implemented by hardware, software, firmware, or any combination thereof.

As shown in the figure, the apparatus 600 comprises a message presenting module 610, configured to, in a session between a user and a digital assistant, in response to receiving a first session message of a user, present a first reply message of the digital assistant for the first session message, the first reply message comprising first content, the first content being generated by a model based on a user requirement corresponding to the first session message. The apparatus 600 further comprises a content adding module 620 configured to, in response to receiving a collection request for the first content, add the first content in the message to the content collection page of the user. The apparatus 600 further comprises a content presenting module 630 configured to, in response to detecting the content viewing request, present second content in the content collection page, the second content being regenerated by the model based on the user requirement.

In some embodiments, the first reply message comprises a collection control for the first content, and wherein the collection request is based on a trigger for the collection control.

In some embodiments, the first content is generated based on a target data source, and wherein the target data source has been updated when the content viewing request is detected and the second content is regenerated based on the updated target data source.

In some embodiments, the message presentation module 610 is further configured to: provide a first session message to the model; receive, from the model, a processing result for the first session message, the processing result comprising an indication of the first content and a flag for whether the first content is reusable; and in response to determining that the processing result comprises the flag for the first content being reusable, present the first reply message comprising the first content.

In some embodiments, the content presenting module 630 is further configured to: provide, to the model, an identifier of a user requirement corresponding to the first session message; and receive, from the model, an indication of the second content.

In some embodiments, the regeneration of the second content is responsive to at least one of the following: in response to detecting the content viewing request, in response to a predetermined content generation policy.

In some embodiments, the apparatus 600 further comprises: a prompt message presenting module, configured to present, in the session, a prompt message that the first content is added to the content collection page, the prompt message comprising an entry indication for the content collection page.

In some embodiments, the content presenting module 630 is further configured to, in response to detecting a trigger operation on the content collection page, present the second content in the content collection page.

In some embodiments, the content presenting module 630 is further configured to: present a content collection page, the content collection page comprising at least a presentation area corresponding to the first content; and in response to detecting an update request for the first content, present the second content in the presentation area.

In some embodiments, the apparatus 600 further comprises: a session message presenting module, configured to present at least a part of the first session message in a presentation area corresponding to the first content or the second content in the content collection page.

In some embodiments, the apparatus 600 further comprises a generation time presenting module configured to present a generation time of the second content in association with the second content.

In some embodiments, the apparatus 600 further comprises: a version entry presenting module configured to present a version viewing entry in association with the second content; and a history version presenting module configured to, in response to detecting a trigger for the version viewing entry, present one or more version options corresponding to the second content, each version option corresponding to a historical version of content generated by the model based on the user requirement.

In some embodiments, the apparatus 600 further comprises a session presenting module configured to, in response to detecting an awakening request for the digital assistant in the content collection page, present a session between the user and the digital assistant.

In some embodiments, an awakening control for the digital assistant is provided in a presentation area of the content collection page, and the awakening request is based on a trigger for the awakening control.

In some embodiments, the content collection page comprises at least one of the following types of content: at least one chart type and at least one form type.

FIG. 7 illustrates a block diagram of an electronic device 700 in which one or more embodiments of the present disclosure may be implemented. It should be understood that the electronic device 700 in FIG. 7 is shown for merely illustrative purpose, and should not limit the functionality and scope of the embodiments described herein. The electronic device 700 shown in FIG. 7 may include or be implemented as the application creation platform 110, the application running platform 140 in FIG. 1, the terminal device 402, server device 404 in FIG. 1, or the apparatus 700 shown in FIG. 7.

As shown in FIG. 7, the electronic device 700 is in the form of a general-purpose computing device. Components of the electronic device 700 may include, but are not limited to, one or more processors or processing units 710, a memory 720, a storage device 730, one or more communications units 740, one or more input devices 750, and one or more output devices 760. The processing unit 710 may be a physical or virtual processor and can perform various processing according to a program stored in the memory 720. In a multiprocessor system, a plurality of processing units executes computer executable instructions in parallel, so as to improve the parallel processing capability of the electronic device 700.

The electronic device 700 typically includes a plurality of computer storage medium. Such media may be any available media that are accessible by the electronic device 700, including, but not limited to, volatile and non-volatile media, removable and non-removable media. The memory 720 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium, such as a flash drive, a magnetic disk, or any other medium that can be used to store information and/or data and that can be accessed within the electronic device 700.

The electronic device 700 may further include additional detachable/undetachable, volatile/nonvolatile storage medium. Although not shown in FIG. 7, a magnetic disk drive for reading from or writing to a detachable, nonvolatile magnetic disk, such as a “floppy disk” and an optical disk drive for reading from or writing to a detachable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 implements communication with other electronic devices through a communication medium. Additionally, functions of components of the electronic device 700 may be implemented by a single computing cluster or a plurality of computing machines, and these computing machines can communicate through a communication connection. Thus, the electronic device 700 may operate in a networked environment using logical connections to one or more other servers, network personal computers (PCs), or another network node.

The input device 750 may be one or more input devices, such as a mouse, a keyboard, a trackball, etc. The output device 760 may be one or more output devices, such as a display, a speaker, a printer, etc. The electronic device 700 may also communicate with one or more external devices (not shown), such as a storage device, a display device, or the like through the communication unit 740 as desired, and communicate with one or more devices that enable a user to interact with the electronic device 700, or communicate with any device (e.g., a network card, a modem, or the like) that enables the electronic device 700 to communicate with one or more other electronic devices. Such communication may be performed via an input/output (I/O) interface (not shown).

According to an example implementation of the present disclosure, a computer readable storage medium is provided, on which computer-executable instructions is stored, wherein the computer-executable instructions are executed by a processor to implement the method described above. According to an example implementation of the present disclosure, a computer program product is also provided, which is tangibly stored on a non-transitory computer readable medium and includes computer-executable instructions that are executed by a processor to implement the method described above.

Aspects of the present disclosure are described herein with reference to flowcharts and/or block diagrams of methods, apparatus, devices and computer program products implemented in accordance with the present disclosure. It should be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, when executed via the processing unit of the computer or other programmable data processing apparatus, create means for implementing the functions/actions specified in one or more blocks of the flowcharts and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture that includes instructions which implement various aspects of the functions/actions specified in one or more blocks of the flowcharts and/or block diagrams.

The computer readable program instructions may be loaded onto a computer, other programmable data processing apparatus, or other devices, causing a series of operational steps to be performed on the computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the present disclosure have been described as above, the foregoing description is illustrative, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

I/We claim:

1. A method of session interaction comprising:
in a session between a user and a digital assistant, in response to receiving a first session message of the user, presenting a first reply message of the digital assistant for the first session message, the first reply message comprising first content, the first content being generated by a model based on a user requirement corresponding to the first session message;
in response to receiving a collection request for the first content, adding the first content in the first reply message to a content collection page of the user; and
in response to detecting a content viewing request, presenting second content in the content collection page, the second content being regenerated by the model based on the user requirement.

2. The method of claim 1, wherein the first reply message comprises a collection control for the first content, and wherein the collection request is based on a trigger for the collection control.

3. The method of claim 1, wherein the first content is generated based on a target data source, and wherein the target data source has been updated when the content viewing request is detected, and the second content is regenerated based on the updated target data source.

4. The method of claim 1, wherein presenting the first reply message comprises:
providing the first session message to the model;
receiving a processing result for the first session message from the model, the processing result comprising an indication of the first content and a flag for whether the first content is reusable; and
in response to determining that the processing result comprises the flag for the first content being reusable, presenting the first reply message comprising the first content.

5. The method of claim 1, wherein presenting the second content comprises:
providing, to the model, an identifier of the user requirement corresponding to the first session message; and
receiving an indication of the second content from the model.

6. The method of claim 1, wherein the regenerating of the second content is responsive to at least one of the following:
in response to detecting the content viewing request,
in response to a predetermined content generation policy.

7. The method of claim 1, further comprising:
presenting, in the session, a prompt message that the first content is added to the content collection page, the prompt message comprising an entry indication for the content collection page.

8. The method of claim 1, wherein presenting the second content comprises:
in response to detecting a trigger operation on the content collection page, presenting the second content in the content collection page.

9. The method of claim 1, wherein presenting the second content comprises:
presenting the content collection page, the content collection page comprising at least a presentation area corresponding to the first content; and
in response to detecting an update request for the first content, presenting the second content in the presentation area.

10. The method of claim 1, further comprising:
presenting at least a part of the first session message in a presentation area corresponding to the first content or the second content in the content collection page.

11. The method of claim 1, further comprising:
presenting a generation time of the second content in association with the second content.

12. The method of claim 1, further comprising:
presenting a version viewing entry in association with the second content; and
in response to detecting a trigger for the version viewing entry, presenting one or more version options corresponding to the second content, each version option corresponding to a historical version of content generated by the model based on the user requirement.

13. The method of claim 1, further comprising:
in response to detecting an awakening request for the digital assistant in the content collection page, presenting the session between the user and the digital assistant.

14. The method of claim 13, wherein an awakening control for the digital assistant is provided in a presentation area of the content collection page, and the awakening request is based on a trigger for the awakening control.

15. The method of claim 1, wherein the content collection page comprises at least one of the following types of content:
at least one chart type, and
at least one form type.

16. An electronic device comprising:
at least one processing unit; and
at least one memory coupled to the at least one processing unit and storing instructions for execution by the at least one processing unit, the instructions, when executed by the at least one processing unit, causing the electronic device to perform at least:
in a session between a user and a digital assistant, in response to receiving a first session message of the user, presenting a first reply message of the digital assistant for the first session message, the first reply message comprising first content, the first content being generated by a model based on a user requirement corresponding to the first session message;
in response to receiving a collection request for the first content, adding the first content in the first reply message to a content collection page of the user; and
in response to detecting a content viewing request, presenting second content in the content collection page, the second content being regenerated by the model based on the user requirement.

17. The electronic device of claim 16, wherein the first reply message comprises a collection control for the first content, and wherein the collection request is based on a trigger for the collection control.

18. The electronic device of claim 16, wherein the first content is generated based on a target data source, and wherein the target data source has been updated when the content viewing request is detected, and the second content is regenerated based on the updated target data source.

19. The electronic device of claim 16, wherein presenting the first reply message comprises:
providing the first session message to the model;
receiving a processing result for the first session message from the model, the processing result comprising an indication of the first content and a flag for whether the first content is reusable; and
in response to determining that the processing result comprises the flag for the first content being reusable, presenting the first reply message comprising the first content.

20. A non-transitory computer-readable storage medium having a computer program stored thereon, the computer program being executable by a processor to implement a method of session interaction comprising:
in a session between a user and a digital assistant, in response to receiving a first session message of the user, presenting a first reply message of the digital assistant for the first session message, the first reply message comprising first content, the first content being generated by a model based on a user requirement corresponding to the first session message;
in response to receiving a collection request for the first content, adding the first content in the first reply message to a content collection page of the user; and
in response to detecting a content viewing request, presenting second content in the content collection page, the second content being regenerated by the model based on the user requirement.
